(19) United States
(12) Patent Application Publication
(10) Pub. No.: US 2017/0135367 A1
(43) Pub. Date: May 18, 2017

(54) PRODUCTION OF CONFECTIONERY USING SUCCESSIVELY OPTIMIZED MOLDING POWDER AND CONFECTIONERY OBTAINABLE THEREBY

(71) Applicant: KATJES FASSIN GMBH. + CO. KOMMANDITGESELLSCHAFT, Emmerich (DE)

(72) Inventor: Bülent Aydin, Bocholt (DE)

(21) Appl. No.: 15/322,426

(22) PCT Filed: Jun. 26, 2015
(86) PCT No.: PCT/EP2015/064530

§ 371 Date: Dec. 27, 2016

(30) Foreign Application Priority Data
Jun. 27, 2014 (DE) 102014009321.2

(51) Int. Cl. A23G 3/50; A23G 3/02; A23G 3/54; A23G 3/34

(52) U.S. Cl. CPC A23G 3/50; A23G 3/0025; A23G 3/0268; A23G 3/34; A23G 3/54

(57) ABSTRACT

The present invention relates to a process comprising as process steps:
a) Providing a confectionery precursor mass,
   wherein the confectionery precursor mass is liquid;
b) Providing a support, supporting a powder,
   wherein the powder includes a powder surface,
   wherein the powder surface comprises a plurality of negative molds;
c) Filling the negative molds with the confectionery precursor mass; and
d) Hardening the confectionery precursor mass;
   wherein the powder has a particle size distribution characterized by a
i) D₁₀ in a range from 6 to 10 μm,
ii) D₅₀ in a range from 12 to 16 μm, and
iii) D₉₀ in a range from 21 to 25 μm.

The invention also relates to a confectionery product produced according to the production process according to the invention, a product comprising a flour, a hard candy with a diameter which is a strictly monotonically decreasing function, use for the production of confectionery, a device for the production of hard candies, a process in this device, and a hard candy, obtainable by this process.

The invention relates to a production process for confectionery, to a confectionery product produced according to the production process, to a product comprising a composition and a flour, to a hard candy with a diameter, whose length is a strictly monotonically decreasing function, to a use for producing confectionery, to a device for the production of hard candies, to a process in this device, and to a hard candy, obtainable by this process.

Confectionery is a widespread and generally popular luxury food. A manner of producing confectionery essentially known in the prior art comprises pouring a liquid confectionery precursor mass into a single- or multi-part mold. The confectionery which is produced in the prior art in this basic manner includes fat-containing confectionery and confectionery made of a sugar mass. A fat-containing confectionery for example is chocolate. The confectionery made of a sugar mass includes candies. Among candies, a distinction is made between hard candies and soft candies. The hard candies also include medicinally active candies such as cough sweets. If a hard candy is provided with a stick for holding, it is described as a lollipop. Soft candies are for example fruit gums, toffees and chews.

Pouring a confectionery precursor mass into a mold of metal, such as for example aluminum, is known in the prior art. In this, to demold the hardened mass which comprises the confectionery product, a knock-out tool pushes through a base of the metal mold. The knock-out tool demolds the confectionery product and in the process gives it an indentation (knock-out mark). This production process of the prior art involves at least the following disadvantages. The production process allows only rather simple confectionery shapes. Further, the candy is inevitably given the knock-out mark, which can be undesirable for the styling of the confectionery product. The metal molds used are rather heavy. Moreover, the metal molds used are rather costly to produce. Further, because of the knock-out tool, the molds used must be rather stable.

In DE 872 149 C, a production process for confectionery is described, in which a metal mold is provided with a rubber lining. During the filling of the mold with the confectionery precursor mass, this rubber lining is laid tightly onto the inside of the metal mold by suction and for the demolding the rubber lining is detached from the metal mold. This production process from the prior art involves at least the following disadvantages. The process contains rather many or fault-prone or both process steps. Possible faults here are for example selected from the group consisting of damage to the rubber lining, production of a confectionery product not shaped as desired and failure of the demolding or a combination of at least two thereof. Further, the process is rather laborious.

Also known in the prior art and likewise mentioned in DE 872 149 C, but also in DE 10 2007 031 747 A1, is pouring of the confectionery precursor mass into a mold of an elastic material, such as for example rubber. Here for demolding the candy, the mold is elastically deformed or everted or both. This process of the prior art involves at least the following disadvantages. The candy can easily be damaged during the demolding. A rather large number of rejects are produced in the process. The demolding does not take place uniformly reproducibly.

Some disadvantages of the aforesaid production process could be avoided in the prior art by using molds which contain dimensionally stable parts, an outer edge and a base, which are connected by elastic parts (DE 872 149 C). However, such molds with supporting structure are rather costly. Further, such molds limit the styling of the confectionery.

Also known in the prior art is the production of confectionery by pouring a confectionery precursor mass into a dimensionally stable plastic mold, for example of polycarbonate. With these molds, the demolding is impeded by adhesion of the candy to the mold. The process is therefore more suitable for fat-containing confectionery such as chocolate. In this, the confectionery product to be demolded is cooled to as low a temperature as possible (EP 0 589 820 A1). DE 10 2007 031 747 A1, for the utilization of inelastic plastic molds for molding hard candy masses, proposes wetting the inner surfaces of the molds with a release agent. The use of the release agent makes the production process more laborious or more costly or both. If in the process not all the inner surfaces of the mold are wetted with the release agent, the confectionery product cannot be demolded, or not simply or not without damaging the mold or the confectionery product. Further, only release agents approved as foods are possible. Even such release agents can be undesirable on the surface of the confectionery product. A release agent can impair the confectionery product's appearance or taste or both. Removal of the release agent from the confectionery product requires at least one further production step.

Also known in the prior art is the use of two half molds for the production of confectionery (DE 40 04 688 A1). In this, the confectionery precursor mass is poured into one of the half molds and the two half molds then joined together. In this process, depending on the material of the mold used, the disadvantages already mentioned above arise during demolding. Further, with the joining of the half molds, the process contains an additional process step. This can be fault-prone, or cause additional costs, or both. Further, the confectionery products produced usually have a seam or a burr or both at a point at which the half molds were joined together. Such elements affecting the styling of the confectionery product are fundamentally undesirable.

Specifically for the production of fruit gums, pouring of the fruit gum mass into a negative mold which is formed of a cornstarch powder is also known in the prior art. In this, the negative mold is pressed into the cornstarch powder by a punch as the positive mold. For this, the cornstarch powder is located in a powder tray. To demold the fruit gums, the powder tray is inverted. In this prior art process, the following disadvantages arise. The negative mold formed by the punch is not dimensionally stable. In particular, in the time between the stamping of the negative mold and the pouring of the fruit gum mass it can become altered or destroyed or both. Moreover, the demolding can fail. A proportion of the cornstarch powder forming the negative mold can remain adhering to the confectionary. If this proportion is too great, this can too strongly affect the appearance or taste of the fruit gum, or both.

In general, it is a purpose of the present invention at least partly to overcome a disadvantage which results from the prior art. A purpose of the invention is to provide a production process for a confectionery product in which a demolding is one selected from the group consisting of less fault-prone, facilitated, simplified, and better reproducible, or a combination of at least two thereof. A further purpose of the invention is to provide a production process for a confectionery product, wherein a negative mold in a powder is more dimensionally stable. Further, it is a purpose of the present invention, to provide a production process for a confectionery product, wherein the confectionery product is produced with the aid of a negative mold in a powder, wherein the powder can be reused as often as possible. Further, a purpose of the present invention, is to provide a production process for a confectionery product, wherein the confectionery product is produced with the aid of a negative mold in a powder, wherein as little as possible fresh powder is needed. A further purpose of the present invention is to provide an inexpensive production process for a confectionery product. Further, it is a purpose of the present invention to provide a production process for a confectionery product, wherein the confectionery product is produced with the aid of a negative mold in a powder, wherein during demolding as little powder as possible remains on the confectionery product. Further, it is a purpose of the present invention to provide a production process for a confectionery product, wherein the production process needs smaller storage capacity for molding tools. Further, it is a purpose of the present invention to provide a production process for a confectionery product, wherein the production process involves lower costs for molding tools. Further, it is a purpose of the present invention to provide a production process for a confectionery product, wherein the production process can easily or rapidly or both be changed over to production of a confectionery product of another shape. It is a purpose of the present invention to provide a confectionery product which contains none selected from the group consisting of a burr, a seam, a knock-out mark and a rim at least partly surrounding the confectionery product. It is a further purpose of the present invention to provide a confectionery product, wherein a design of a surface of the confectionery product can be executed as diversely as possible. Further, it is a purpose of the present invention to provide a hard candy which possesses at least one of the aforesaid advantages of a confectionery product. Further, it is a purpose of the invention to provide a hard candy comprising two or more layers. A further purpose of the invention is to provide two or multicolored hard candies. It is a purpose of the present invention to provide a multilayer hard candy containing one or more layers produced from a foam mass, or one or more layers produced from a fruit mass, or both. Further it is a purpose of the present invention, to provide a production process for a hard candy, which possesses at least one of the aforesaid advantages of a production process. In addition, it is a purpose of the invention to provide a production process for a hard candy, wherein the production process includes simultaneous pouring of two or more different hard candy precursor mass, preferably two or more different-colored hard candy precursor mass, into a mold.

A contribution to the at least partial fulfilment of at least one of these purposes is achieved through the independent claims. The dependent claims provide preferred embodiments which contribute to the at least partial fulfilment of at least one of the purposes.

A contribution to the fulfilment of at least one of the purposes according to the invention is achieved by a process comprising as process steps:
a) Providing a confectionery precursor mass,
   wherein the confectionery precursor mass is liquid;
b) Providing a support, supporting a powder,
   wherein the powder includes a powder surface,
   wherein the powder surface comprises a plurality of negative molds;
c) Filling the negative molds with the confectionery precursor mass;
d) Hardening the confectionery precursor mass;
   wherein the powder has a particle size distribution characterized by a
i) D₁₀ in a range from 6 to 10 μm, preferably from 7 to 9 μm, more preferably from 8 to 8.8 μm, most preferably from 8.35 to 8.55 μm,
ii) D₅₀ in a range from 12 to 16 μm, preferably from 13 to 15 μm, more preferably from 14 to 15 μm, most preferably from 14.2 to 14.7 μm, and
iii) D₉₀ in a range from 21 to 25 μm, preferably from 22 to 24.5 μm, more preferably from 22.5 to 24.5 μm, most preferably from 22.8 to 24.1 μm.

A preferred hardening comprises a cooling of the confectionery precursor mass. A preferred cooling is effected by an active cooling process or passively or both. A preferred support is a container. A preferred container is a tray. A preferred filling of the negative molds with the confectionery precursor mass is a pouring. A preferred pouring includes a simultaneous pouring of the confectionery precursor mass and at least one further confectionery precursor mass. A preferred further confectionery precursor mass contains a color different from a color of the confectionery precursor mass.

In one embodiment according to the invention, the particle size distribution of the powder is further characterized by a
i) D₁₆ in a range from 8 to 11 μm, preferably from 8.5 to 10.5 μm, more preferably from 9 to 10 μm, most preferably from 9.5 to 9.9 μm,
ii) D₈₄ in a range from 19 to 22 μm, preferably from 19.5 to 21.5 μm, more preferably from 20 to 21.3 μm, most preferably from 20.3 to 21.2 μm, and
iii) D₉₅ in a range from 25 to 30 μm, preferably from 25.5 to 29.5 μm, more preferably from 26 to 29 μm, most preferably from 26.3 to 28.5 μm.

In one embodiment according to the invention, the particle size distribution of the powder is further characterized by a
i) Q₁₀ in a range from 15 to 20 vol. %, preferably from 15.5 to 19.5 vol. %, more preferably from 16 to 19 vol. %, most preferably from 17.2 to 18.3 vol. %,
ii) Q₂₀ in a range from 78 to 85 vol. %, preferably from 78.5 to 84.5 vol. %, more preferably from 79 to 84 vol. %, most preferably from 79.5 to 82.7 vol. %,
iii) Q₄₀ in a range from 97 to 100 vol. %, preferably from 97.5 to 99.9 vol. %, more preferably from 98 to 99.9 vol. %, most preferably from 98.5 to 99.8 vol. %, and
iv) Q₅₀ in a range from 99 to 100 vol. %, preferably from 99.2 to 100 vol. %, more preferably from 99.3 to 99.9 vol. %,
   each based on the total volume of the powder.

In one embodiment according to the invention, the powder is a flour.

In one embodiment according to the invention, the powder has a water content in a range from 2 to 10 g/100 g, preferably in a range from 3 to 9 g/100 g, more preferably in a range from 3.5 to 8.5 g/100 g, still more preferably in a range from 4 to 7.5 g/100 g, most preferably in a range from 4.6 to 6.5 g/100 g, based on the powder.

In one embodiment according to the invention, the confectionery precursor mass is a hard candy mass.

In one embodiment according to the invention, the hardening of the confectionery precursor mass in process step d) a conditioning for a period in a range from 0.5 to 10 hours, preferably from 0.5 to 8 hours, more preferably from 1 to 5 hours, to a temperature in a range from 25 to 65° C., preferably in a range from 30 to 55° C., more preferably in a range from 35 to 50° C., most preferably in a range from 35 to 45° C. Preferably these temperatures are maintained in the room, which is often configured as a drying room, in which the process step d) takes place. If a hard candy mass is used as the confectionery precursor mass, it is preferable to maintain the temperature in a range from 25 to 55° C., preferably in a range from 26 to 45° C., more preferably in a range from 27 to 40° C., most preferably in a range from 28 to 35° C.

A contribution to the fulfilment of at least one of the purposes according to the invention is achieved by a confectionery product, obtainable by a process according to the invention.

A contribution to the fulfilment of at least one of the purposes according to the invention is achieved by a product comprising a confectionery product, a confectionery surface and a flour; wherein the flour at least partly superimposes the confectionery surface.

A preferred confectionery product is a candy. Here it is not necessary that the flour is visible with the naked eye or optically covers a part of the confectionery surface at all. Rather, the flour should be detectable by a suitable detection method. A preferred detection method is starch detection by an iodine test or by the iodine-starch reaction or both. Preferably, the product comprises only traces of the flour. Furthermore, the flour preferably does not impair the optical appearance or the taste of the confectionery product or both.

In one embodiment according to the invention, the confectionery product is a hard candy.

In one embodiment according to the invention, the flour has a particle size distribution characterized by a
i) D₁₀ in a range from 6 to 10 μm, preferably from 7 to 9 μm, more preferably from 8 to 8.8 μm, most preferably from 8.35 to 8.55 μm,
ii) D₅₀ in a range from 12 to 16 μm, preferably from 13 to 15 μm, more preferably from 14 to 15 μm, most preferably from 14.2 to 14.7 μm, and
iii) D₉₀ in a range from 21 to 25 μm, preferably from 22 to 24.5 μm, more preferably from 22.5 to 24.5 μm, most preferably from 22.8 to 24.1 μm.

In one embodiment according to the invention, the flour has a particle size distribution characterized by a
i) D₁₆ in a range from 8 to 11 μm, preferably from 8.5 to 10.5 μm, more preferably from 9 to 10 μm, most preferably from 9.5 to 9.9 μm,
ii) D₈₄ in a range from 19 to 22 μm, preferably from 19.5 to 21.5 μm, more preferably from 20 to 21.3 μm, most preferably from 20.3 to 21.2 μm, and
iii) D₉₅ in a range from 25 to 30 μm, preferably from 25.5 to 29.5 μm, more preferably from 26 to 29 μm, most preferably from 26.3 to 28.5 μm.

In one embodiment according to the invention, the flour has a particle size distribution characterized by a
i) Q₁₀ in a range from 15 to 20 vol. %, preferably from 15.5 to 19.5 vol. %, more preferably from 16 to 19 vol. %, most preferably from 17.2 to 18.3 vol. %,
ii) Q₂₀ in a range from 78 to 85 vol. %, preferably from 78.5 to 84.5 vol. %, more preferably from 79 to 84 vol. %, most preferably from 79.5 to 82.7 vol. %,
iii) Q₄₀ in a range from 97 to 100 vol. %, preferably from 97.5 to 99.9 vol. %, more preferably from 98 to 99.9 vol. %, most preferably from 98.5 to 99.8 vol. %, and
iv) Q₅₀ in a range from 99 to 100 vol. %, preferably from 99.2 to 100 vol. %, more preferably from 99.3 to 99.9 vol. %,
   each based on the total volume of the flour.

In one embodiment according to the invention, the flour has a water content in a range from 2 to 10 g/100 g, preferably in a range from 3 to 9 g/100 g, more preferably in a range from 3.5 to 8.5 g/100 g, still more preferably in a range from 4 to 7.5 g/100 g, most preferably in a range from 4.6 to 6.5 g/100 g, based on the powder.

A contribution to the fulfilment of at least one of the purposes according to the invention is achieved by a hard candy including a surface;

wherein the surface consists of a bottom surface, a top surface, and a lateral surface;
wherein the top surface
a) lies opposite the bottom surface, and
b) is connected with the bottom surface by the lateral surface;
   wherein a diameter of the hard candies is a strictly monotonically decreasing function of a position on a connecting straight line from the bottom surface to the top surface. Here, the diameter of the hard candy is a length of a shortest straight line which is obtained when the hard candy is laid with the bottom surface on a flat surface, and joins two points on the surface of the hard candy in a cross-sectional plane through the hard candy parallel to the flat surface, wherein the straight line includes a geometric center of gravity of the hard candy in the cross-sectional plane. A preferred hard candy here has approximately the shape of a truncated cone or a truncated pyramid or both, wherein the bottom surface does not obligatorily have to be oriented parallel to the top surface. In the above case, the diameter of the hard candy is determined in a cross-sectional plane perpendicular to a height of the truncated cone or the truncated pyramid or both. A preferred hard candy herein is strictly monotonically tapered from the bottom surface up to the top surface. A further preferred hard candy comprises a first layer and at least one further layer. A preferred further layer contains a color which is different from a color of the at least one further layer. A further preferred hard candy is multicolored. In this case, different-colored regions of the hard candy are preferably spatially separated from one another. The different-colored regions can be spatially separated from one another in that they are one selected from the group consisting of horizontally spatially separated, vertically spatially separated and intertwined or a combination of at least two thereof. A further preferred at least one further layer is produced from a foamed gum mass or produced from a fruit gum mass or both. A further preferred hard candy comprises a first layer produced from a hard candy mass and a first further layer produced from a foamed gum mass and a second further layer produced from a fruit gum mass. In this, the preferred foamed gum mass is a soft candy precursor mass of foamy consistency. Here a fruit gum mass is a non-foamy soft candy precursor mass. A preferred non-foamy soft candy precursor mass is a fruit gum precursor mass.

In one embodiment according to the invention, the top surface includes a relief. A preferred relief comprises an embossed pattern or an embossed figurative representation or both. A preferred figurative representation comprises one selected from the group consisting of a symbol, a letter, a numeral and a three-dimensional portrayal or a combination of at least two thereof. A preferred three-dimensional portrayal is a portrayal of one selected from the group consisting of an object, a means of transport, a living being, a food, a foodstuff and a constituent of one of the aforesaid or a combination of at least two thereof. A preferred means of transport is one selected from the group consisting of a train, an automobile and an aircraft or a combination of at least two thereof. A preferred living being is one selected from the group consisting of a person, an animal and a plant or a combination of at least two thereof. A preferred food is a fruit. A preferred foodstuff is a fruit. Here it is irrelevant how realistic, distorted or idealized the three-dimensional portrayal is compared to a model.

In one embodiment according to the invention, the hard candy comprises none selected from the group consisting of a burr, a seam, a rim running at least partly around the hard candy, and a knock-out mark. A preferred knock-out mark is an imprint on one surface of the hard candy, wherein the imprint has been stamped by a knock-out tool. A preferred knock-out tool pushes the hard candy out of a mold (demolding). A further preferred knock-out tool is a knock-out pin. A preferred burr is a pointed or sharp-edged or both projecting part on a surface of the hard candy. A further preferred burr arises during one selected from the group consisting of a molding of a hard candy precursor mass to a hard candy, a demolding of the hard candy from a mold, a casting process and a stamping or a combination of at least two thereof. A preferred seam is one selected from the group consisting of a linear protrusion, a linear depression and a linear misalignment or a combination of at least two thereof on a surface of the hard candy, wherein the seam is objectively undesired in a molding of the hard candy. A seam is preferably objectively undesired, if it would not occur in an optimal implementation of a production process. A seam is furthermore preferably objectively undesired, if it is an indentation of the surface of the hard candy which is not provided in a mold defining the hard candy. A further preferred seam arises during production of the hard candy in a multi-part negative mold. A further preferred seam arises during joining together of several hard candy pieces to make the hard candy. A preferred seam or a preferred burr or both are located on a lateral surface of a surface of the hard candy.

In one embodiment according to the invention, the bottom surface is concave. Herein, a bottom surface is concave if the bottom surface from an edge of the bottom surface to a geometric center of gravity of the bottom surface protrudes in the direction of the top surface. Preferably the geometric center of gravity of the bottom surface lies at least 0.5 mm, preferably at least 0.75 mm, most preferably at least 1 mm, higher than the edge of the bottom surface, if the hard candy is laid on a flat horizontal surface with the bottom surface downwards. Preferably, no point of the bottom surface lies higher than the geometric center of gravity of the bottom surface, if the hard candy is laid on a flat horizontal surface with the bottom surface downwards. A particularly preferred bottom surface is not flat or not convex or both.

A contribution to the fulfilment of at least one of the purposes according to the invention is achieved by a use of a support and a flour for the production of confectionery;

wherein the support supports a flour;
wherein the flour
a) comprises a flour surface,
b) has a particle size distribution characterized by a
   i) D₁₀ in a range from 6 to 10 μm, preferably from 7 to 9 μm, more preferably from 8 to 8.8 μm, most preferably from 8.35 to 8.55 μm,
   ii) D₅₀ in a range from 12 to 16 μm, preferably from 13 to 15 μm, more preferably from 14 to 15 μm, most preferably from 14.2 to 14.7 μm, and
   iii) D₉₀ in a range from 21 to 25 μm, preferably from 22 to 24.5 μm, more preferably from 22.5 to 24.5 μm, most preferably from 22.8 to 24.1 μm,
c) has a water content in a range from 2 to 10 g/100 g, preferably in a range from 3 to 9 g/100 g, more preferably in a range from 3.5 to 8.5 g/100 g, still more preferably in a range from 4 to 7.5 g/100 g, most preferably in a range from 4.6 to 6.5 g/100 g, based on the flour (102);
   wherein the flour surface (103) comprises a plurality of negative molds (104). The particle size distributions stated above also apply as preferable for the present configuration.

A contribution to the fulfilment of at least one of the purposes according to the invention is achieved by a device for the production of hard candies in a process sequence, wherein the device comprises
a) a first container, designed to receive a powder, wherein the first container is connected with a powder outlet, designed for filling of a support with the powder;
b) a squeegee, wherein the squeegee
   i) is positioned downstream of the powder outlet, and
   ii) is designed to wipe off the powder in the support thereby obtaining a powder surface;
c) a stamping device, wherein the stamping device
   i) is positioned downstream of the squeegee, and
   ii) is designed to stamp a plurality of negative molds into the powder surface;
d) a further container, designed to receive a liquid hard candy mass, wherein the further container is connected to a hard candy mass outlet, designed for filling the negative molds with the liquid hard candy mass, wherein the hard candy mass outlet is positioned downstream of the stamping device;
e) a cooling device, wherein the cooling device
   i) is positioned downstream of the hard candy mass outlet, and
   ii) is designed to cool the hard candy mass in the negative molds thereby obtaining a plurality of hard candies;
f) a demolding device, wherein the demolding device
   i) is positioned downstream of the cooling device, and
   ii) is designed to demold the hard candies from the negative molds; and
g) a conveying device, positioned and designed for conveying the support downstream from the powder outlet to the hard candy mass outlet.

Herein the statement downstream preferably relates to a process sequence of a process, for the implementation whereof the device is designed. The process is preferably a continuous process. The process sequence is preferably a circuit. If in that case a first device or component of the device is positioned downstream of a further device or component, then the further device or component is positioned behind the device or component in the process sequence in the direction towards the end product of the process. Here a preferred process is a production process for hard candies. A preferred end product is a hard candy. A preferred cooling device is one selected from the group consisting of a cooling room, a drying room and a ripening room or a combination of at least two thereof. A preferred support is a container. A preferred container is a tray, preferably a powder tray. A preferred filling of the negative molds with the hard candy mass is a pouring. A preferred pouring comprises a simultaneous pouring of the hard candy mass and at least one further confectionery precursor mass. A preferred further confectionery precursor mass comprises a color different from a color of the hard candy mass. A preferred hard candy mass outlet is a nozzle. A preferred conveying device is a conveyor belt or a production line or both. A further preferred conveying device contains a plurality of rotating rollers. A preferred demolding device is designed for inverting the support, so that a major part of the powder and the hard candies fall out from the support. Preferably the demolding device includes a grating onto which the hard candies fall. A preferred grating comprises apertures through which particles of the powder can fall, and the hard candies remain on the grating. A preferred demolding device is an inverting table. A preferred further container is equipped with heating or thermally insulated or both. A preferred stamping device comprises a plurality of mold punches. A preferred device is a mogul plant. The device is preferably designed for the production of hard candies.

In one embodiment according to the invention, the cooling device is designed for cooling the hard candy mass in the negative molds at a cooling device temperature in a range from 25 to 55° C., preferably in a range from 26 to 45° C., more preferably in a range from 27 to 40° C., most preferably in a range from 27 to 35° C., for a cooling time in a range from 0.5 to 10 hours, preferably from 0.5 to 8 hours, more preferably from 1 to 5 hours. A preferred cooling device temperature is an ambient temperature, preferably of conditioned ambient air, in the cooling device.

A contribution to the fulfilment of at least one of the purposes according to the invention is achieved by a process for the production of hard candies in the device according to the invention. Preferably the further configurations of the processes stated in this text also apply here, wherein each of these configurations can be individually combined with this process.

In one embodiment according to the invention, the hard candy mass in the negative molds is conditioned at a cooling device temperature in a range from 25 to 55° C., preferably in a range from 26 to 45° C., more preferably in a range from 27 to 45° C., more preferably in a range from 27 to 40° C., more preferably in a range from 27 to 35° C., most preferably in a range from 15 to 20° C., for a period in a range from 0.5 to 10 hours, preferably from 0.5 to 8 hours, more preferably from 1 to 5 hours.

A hard candy, obtainable by the process according to the invention for the production of hard candies.

### Confectionery Product

A preferred confectionery product is a fat-containing confectionery product or a confectionery product from a sugar mass or both. A preferred fat-containing confectionery product comprises a chocolate or a cocoa or both. A preferred confectionery product from a sugar mass is a candy. A preferred sugar mass is a boiled sugar mass. A preferred candy is a soft candy or a hard candy or both. A further preferred boiled sugar mass comprises sucrose, glucose syrup, flavoring and luxury food acid. A preferred boiled sugar mass in addition to the aforesaid comprises a colorant.

A soft candy preferably has a highly viscous, chewy consistency. Soft candies are preferably chewed when consumed. During chewing, the soft candy preferably dissolves gradually. A preferred soft candy has a water content in a range from 1 to 20 wt. %, preferably in a range from 5 to 20 wt. %, more preferably in a range from 10 to 20 wt. %, most preferably in a range from 15 to 20 wt. %, based on the total weight of the soft candy. A preferred soft candy is elastically deformable. A particularly preferred soft candy has a Shore hardness A of 70 or less, preferably 65 or less, more preferably 60 or less, more preferably 60 or less, more preferably 55 or less, more preferably 50 or less, more preferably 45 or less, more preferably 40 or less, more preferably 35 or less, more preferably 30 or less, more preferably 25 or less, more preferably 20 or less, still more preferably 20 or less, still more preferably 15 or less, most preferably 10 or less. A further preferred soft candy is one selected from the group consisting of a fruit gum, a toffee and a chew or a combination of at least two thereof. A further preferred soft candy contains a hydrocolloid. A preferred hydrocolloid is gelatin.

A very especially preferred candy is a hard candy. A hard candy is preferably hard and brittle. A preferred hard candy is not elastically deformable. A preferred hard candy comprises a glass-like body. A further preferred hard candy has a water content in a range from 1 to 4 wt. %, preferably in a range from 1 to 3 wt. %, based on the total weight of the hard candy. Hard candies are preferably sucked during consumption. They are also described as boiled sweets. The term hard candy also includes hard candies with a stick, which are called lollipops. A quite especially preferred hard candy has a Shore hardness A of greater than 70, preferably greater than 75, more preferably greater than 80, more preferably greater than 85, more preferably greater than 90, still more preferably greater than 95, most preferably 100. A further preferred hard candy is hygroscopic. A further preferred hard candy has a GF value of less than 30%. A further preferred hard candy comprises no gelatin.

A further preferred candy comprises licorice. The hard candies also include bonbons, caramels, sweet-balls and the like. A further preferred candy comprises a filling. A preferred filling is liquid or viscous or both. The term candy as well as sweet-tasting confectionery also includes confectionery with other flavors such as for example sour or salty or both. Further, the term confectionery as well as confectionery luxury food also includes confectionery with a medicinal action such as for example cough sweets or sore throat lozenges.

### Confectionery Precursor Mass

A confectionery precursor mass is a mass from which a confectionery product can be produced by further processing. A preferred confectionery precursor mass is a hard candy mass. A preferred hard candy mass comprises as an essential component a sugar or a sugar substitute or both. A preferred sugar is one selected from the group consisting of a polysaccharide, sucrose, glucose, fructose and invert sugar or a combination of at least two thereof. A preferred sugar substitute is one selected from the group consisting of isomalt, mannitol, sorbitol, xylitol and polydextrose or a combination of at least two thereof. A further preferred hard candy mass further comprises one selected from the group consisting of a milk preparation, a plant fat, an emulsifier, a dye mixture, an oil, an active substance, a plant extract and a flavoring or a combination of at least two thereof. A preferred oil is an essential oil. A preferred essential oil is one selected from the group consisting of an eucalyptus oil, a mint oil and a menthol or a combination of at least two thereof. A preferred active substance displays one selected from the group consisting of a mucolytic action, an analgesic action, a swelling-alleviating action and an inflammation-inhibiting action or a combination of at least two thereof. A preferred plant extract is one selected from the group consisting of a herbal extract, a root extract and a bark extract or a combination of at least two thereof. A preferred herbal extract is an extract from one selected from the group consisting of sage, ribwort plantain, cowslip and marsh mallow or a combination of at least two thereof. A preferred root extract is a licorice root extract, often also described as licorice. A preferred flavoring is an artificial flavoring or a natural flavoring or both. A further preferred flavoring is a fruit flavoring. During pouring into a mold, a hard candy mass preferably has a processing temperature in a range from 80 to 150° C., preferably in a range from 90 to 140° C., more preferably in a range from 100 to 120° C. The processing temperature which a confectionery precursor mass has during pouring is selected such that the confectionery precursor mass is characterized by good flow properties. In this state, the confectionery precursor mass is described as liquid.

### Powder

A preferred powder is a flour. A preferred flour is a plant flour. A preferred plant flour is a cornstarch flour. The flour is often also described as powder. A powder according to the invention is successively optimized. A powder is preferably successively optimized in that it is used multiple times for production of confectionery by pouring a confectionery precursor mass into negative molds made of the powder. During this, during each n^{th} use a fraction of the reused powder is replaced by a fraction of powder not yet used for production of confectionery. Here n is a natural number which is greater than 1. A preferred n is selected such that once per day in an operating process a portion of the reused powder is replaced by a portion of powder not yet used for production of confectionery. If the procedure described, namely that in each n^{th} confectionery production run only a part of the powder is replaced by unutilized powder, is repeated sufficiently often, then after a sufficiently high number of repetitions a static composition of the powder used in the subsequent confectionery production runs is established, wherein the static composition comprises approximately constant fractions of unutilized powder and of powder which has been used for a certain number of confectionery production runs. A successively optimized powder has a particle size distribution according to the invention.

### Particle Size Distribution

For specifying particle size distributions, according to the invention values Dₓ and Q_{y} are used. Here x is a natural number in % and y a natural number in μm. Dₓ states the particle diameter in μm for which x wt. % of the particles are smaller than this particle diameter, based on the total weight of the particles. Q_{y} states the proportion of the particles in vol. % based on the total volume of the particles which have a particle diameter of less than y μm. Here the particle diameter is a length of the longest straight line which has a starting point and a finishing point on the surface of the particle, wherein the straight line passes through a geometric center of gravity of the particle.

### Measurement Methods

The following measurement methods were used in the context of the invention. Unless otherwise stated, the measurements were performed at an ambient temperature of 25° C., an ambient atmospheric pressure of 100 kPa (0.986 atm) and a relative atmospheric humidity of 50%.

### Shore Hardness

For measuring the Shore hardness, the method according to VDI/VDE 2616-Sheet 2 (2004-04): “Hardness Testing on Plastics and Rubber” was used.

### Particle Size Distribution

The particle size distributions were measured with a HELOS laser refraction system (complies with ISO Standard 13320) from Sympatec GmbH System-Partikel-Technik, Clausthal-Zellerfeld, Germany. For this, the measurement range R3, the lens focal length f 100 mm and an x_{Mb} from 0.5/0.9 to 175.0 μm (the detected particle size range of a measurement ranges with statement of the first class—lower class limit/upper class limit—and upper limit of the coarsest class) was selected. As the dispersion system, the dry dispersion system RODOS/M from Sympatec GmbH System-Partikel-Technik, Clausthal-Zellerfeld, Germany was used. To minimize the sampling and sample splitting errors, the splitting of the material to be measured to the amounts required for the measurement was effected by means of a rotating riffle splitter. For each sample, 3 part samples were each measured once and the mean value for each sample, namely over the 3 part samples, calculated. The assessment of the measurement data was based on the Fraunhofer theory with the Sympatec assessment mode FREE (Version 5.8.2.0). According to the Fraunhofer theory, the refraction of light is assumed to be the predominant interaction between the particles and the laser light. Further parameters of the measurements are summarized in the list below.

| | |
|---|---|
| Sample weight | 1.50 g |
| Starting condition for measurement | c.opt ≧1% |
| Stop condition for measurement | 2 s c.opt ≦1% or 20 s real time |
| Time-base | 10.00 ms |
| Feed rate VIBRI | 50.00% |
| Funnel height | 15.00 mm |
| Internal diameter of dispersion section | 4.00 mm |
| Inlet pressure | 1.50 bar |

### Water Content

For measuring the water content, the following instruments were used: a Sartorius MA 30 moisture analyzer (Sartorius AG, Gottingen, Germany), aluminum weighing pan and spoon. The moisture analyzer is not preheated before the measurement. If a measurement has already been performed with the moisture analyzer, the moisture analyzer is left cooling with open hood for at least 15 minutes prior to a further measurement. The moisture analyzer is switched on. The measurement parameters are 105° C. (drying temperature), Auto, 0-100%. The hood is opened and an aluminum pan put in. Zeroing is performed with the Enter key. A sample of mass 5.0 to 5.5 g is prepared. The aluminum pan is placed on a table and the sample uniformly distributed on the pan with the spoon. The pan is placed on the holder and the hood is closed. The moisture analyzer starts the measurement process automatically. When the moisture analyzer displays “END”, the measurement result is read off.

### EXAMPLES

The invention is presented more precisely below by examples and drawings, wherein the examples and drawings do not signify any limitation of the invention.

### Example 1—Hard Candy

Example 1 relates to the production according to the invention of a hard candy according to the invention.

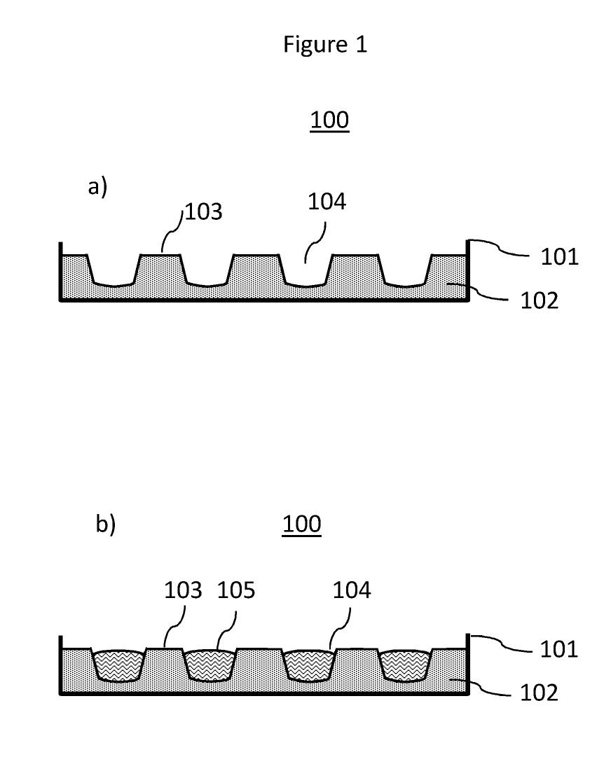

Firstly, a powder tray was provided as a support according to FIG. 1a) for a molding powder. As molding powder, a cornstarch flour which had a particle size distribution characterized by a D₁₀ of 8.38 μm, a D₁₆ of 12 μm, a D₅₀ of 14.27 μm, a D₈₄ of 22.5 μm, a D₉₀ of 22.95 μm, a D₉₅ of 35 μm, and by a Q₁₀ of 13.4 vol. %, a Q₂₀ of 75.4 vol. %, a Q₄₀ of 95.6 vol. %, and a Q₅₀ of 97.4 vol. % was used. Further, the cornstarch flour had a water content of 12.6 g/100 g based on the cornstarch flour. The powder tray was filled with the cornstarch flour and this was wiped off to give a flat cornstarch flour surface in the powder tray. A molding punch of plaster/stainless steel for stamping negative molds for the hard candy casting was prepared. The molding punch consisted of a holding part and a further part which has the positive shape of a hard candy to be produced. Here the lower punch surface of the molding punch, which is pressed into the powder during the stamping, corresponds to the top surface of the hard candy to be produced. This punch surface contains a relief. The relief is a three-dimensional representation of a part of a surface of a raspberry. With the molding punch, negative molds were stamped into the cornstarch surface by stamping. The negative molds were evenly distributed over the cornstarch surface, wherein the molding punch was only stamped into the cornstarch surface to a depth such that at least 1 cm cornstarch flour remained under each negative mold. This is also shown schematically in FIG. 1b). After each stamping, the molding punch was removed vertically upwards without damaging the stamped negative mold.

After this, a formula for a hard candy precursor mass was prepared by weighing out the raw materials. The formula consisted of
47 wt. % sucrose of purity 99.5%, pH 7, sweetness 100, and EC category I;
36 wt. % glucose syrup, a DE 42 SE was used, pH 4.8 to 5.3, dry substance ca. 80 wt. % of the glucose syrup, wherein the dry substance comprises 6 wt. % dextrose, 37 wt. % maltose, and 57 wt. % polysaccharide, each based on the dry substance;
15 wt. % water, compliant with the drinking water decree;
1.5 wt. % acid, buffered lactic acid, residual water 20 wt. % based on the acid, acid strength 80, inversion rate 0.49;
0.25 wt. % dye, from plant extracts; and
0.25 wt. % flavoring, natural flavoring from fruit as concentrate;
   each based on the formula.

After this, the sucrose and the water of the formula were passed into a copper boiling vessel of sufficient capacity and the sucrose dissolved at 110° C. Then the glucose syrup was added and the resulting solution in the copper boiling vessel end-boiled to 155 to 160° C. with constant stirring with a stirring spoon, in order to reach a dry substance content in a range from 97 to 98 wt. % of the mass obtained. The boiling time was about 8 minutes. Next the mass was left without heat input and thus cooled to about 135° C. At this temperature, the dye, the flavoring and the acid were added according to the formula, stirred in and a hard candy precursor mass thus obtained. The hard candy precursor mass formed was used to fill by pouring the negative molds in the cornstarch flour created as described above. Filled negative molds according to FIG. 1b) were obtained. Next, the hard candy precursor mass was left in the negative molds until it was cooled and solid. Hard candies were thereby obtained. The hard candies were removed from the powder tray by hand and laid in a kitchen sieve. With shaking of the kitchen sieve, the hard candies were freed of adhering cornstarch flour with compressed air. The hard candies were now packed in foil at 17° C. room temperature and an atmospheric humidity of ca. 40% and then stored at 20° C. and an atmospheric humidity of less than 60%.

### Example 2—Hard Candy

Example 2 relates to a further production according to the invention of a further hard candy according to the invention. Example 2 was performed identically to example 1, differing however in that cornstarch was used as the molding powder. In example 2, a cornstarch flour which had a particle size distribution characterized by a D₁₀ of 8.49 μm, a D₁₆ of 9.78 μm, a D₅₀ of 14.58 μm, a D₈₄ of 21.1 μm, a D₉₀ of 23.5 μm, a D₉₅ of 27.97 μm, and by a Q₁₀ of 17.41 vol. %, a Q₂₀ of 81.98 vol. %, a Q₄₀ of 98.7 vol. %, and a Q₅₀ of 99.9 vol. % was used. Further, the cornstarch flour had a water content of 12.4 g/100 g based on the cornstarch flour.

### Example 3—Hard Candy

Example 3 relates to a further production according to the invention of a further hard candy according to the invention. Example 3 was performed identically to example 1, differing however in that cornstarch was used as the molding powder. In example 3, a cornstarch flour according to FIG. 1a) which had a particle size distribution characterized by a D₁₀ of 8.41 μm, a D₁₆ of 9.69 μm, a D₅₀ of 14.38 μm, a D₈₄ of 20.48 μm, a D₉₀ of 23.02 μm, a D₉₅ of 26.64 μm, and by a Q₁₀ of 17.76 vol. %, a Q₂₀ of 82.08 vol. %, a Q₄₀ of 99.07 vol. %, and a Q₅₀ of 99.45 vol. % was used. Further, the cornstarch flour had a water content of 5 g/100 g based on the cornstarch flour.

### Example 4—Soft Candy

Example 4 relates to the production according to the invention of a soft candy according to the invention. Firstly, a powder tray was provided as a support according to FIG. 1a) for a molding powder. As molding powder, a cornstarch flour which had a particle size distribution characterized by a D₁₀ of 8.49 μm, a D₁₆ of 13.01 μm, a D₅₀ of 14.57 μm, a D₈₄ of 23.1 μm, a D₉₀ of 23.92 μm, a D₉₅ of 33.7 μm, and by a Q₁₀ of 13.9 vol. %, a Q₂₀ of 76.6 vol. %, a Q₄₀ of 95.95 vol. %, and a Q₅₀ of 97.88 vol. % was used. Further, the cornstarch flour had a water content of 13.8 g/100 g based on the cornstarch flour. The powder tray was filled with the cornstarch flour and this was wiped off to give a flat cornstarch flour surface in the powder tray. A molding punch of plaster/stainless steel for stamping negative molds for the candy casting was prepared. The molding punch consisted of a holding part and a further part which has the positive shape of a candy to be produced. Here the lower punch surface of the molding punch, which is pressed into the powder during the stamping, corresponds to the top surface of the hard candy to be produced. This punch surface comprises a relief. The relief is a three-dimensional representation of a part of a surface of a strawberry. With the molding punch, negative molds were stamped into the cornstarch surface by stamping. The negative molds were evenly distributed over the cornstarch surface, wherein the molding punch was only stamped into the cornstarch surface to a depth such that at least 1 cm cornstarch flour remained under each negative mold. This is also shown schematically in FIG. 1a). After each stamping, the molding punch was removed vertically upwards, without damaging the stamped negative mold.

Firstly, a formula was prepared by weighing out the raw materials. The formula consists of 47 wt. % sucrose, 31 wt. % glucose syrup, 15 wt. % water, % wt. % gelatin, 1.5 wt. % acid, 0.25 wt. % dye and 0.25 wt. % flavoring, each based on the formula.

After this, a formula for a soft candy precursor mass was prepared by weighing out the raw materials. The formula consisted of
44 wt. % sucrose of purity 99.5%, a pH of 7, sweetness 100, and EC category I;
31 wt. % glucose syrup, a DE 42 SE was used, pH 4.8 to 5.3, dry substance ca. 80 wt. % of the glucose syrup, wherein the dry substance comprises 6 wt. % dextrose, 37 wt. % maltose, and 57 wt. % polysaccharide, each based on the dry substance;
17 wt. % water, compliant with the drinking water decree;
6 wt. % gelatin, containing 84 to 86 wt. % protein, 9 to 12 wt. % water, 2 to 4 wt. % inorganic substances, each based on the gelatin;
1.5 wt. % acid, citric acid monohydrate, residual water 8.6 wt. % based on the acid, acid strength 90, inversion rate 0.64;
0.25 wt. % dye, from fruit extracts; and
0.25 wt. % flavoring, natural flavoring from fruit as concentrate;
   each based on the formula.

After this, the gelatin was dissolved in the water according to the formula and a gelatin solution obtained. Next, the sucrose of the formula was placed in a copper boiling vessel of adequate capacity and the sucrose dissolved at 110° C. Then the glucose syrup was added and the resulting solution end-boiled to 116° C. in the copper boiling vessel with constant stirring with a stirring spoon. The boiling time was about 8 minutes. Next the mass was left without heat input and thus cooled to about 90° C. At this temperature, the gelatin solution, the dye, the flavoring and the acid were added according to the formula, and stirred in and a soft candy precursor mass thus obtained. For degassing, the soft candy precursor mass was allowed to stand for 10 minutes. The soft candy precursor mass was now placed in a pouring bag. The pouring bag was used to fill the negative molds in the cornstarch flour created as described above with the soft candy mass by pouring. During the pouring, the soft candy precursor mass had a temperature of ca. 70° C. Filled negative molds were obtained. The soft candy precursor mass in the negative molds in the powder tray was matured in the drying room for 48 hours at a temperature of 30° C. and soft candies were thereby obtained. The powder tray was now inverted, so that the soft candies produced were demolded from the negative molds, and soft candies and cornstarch flour fell out of the powder tray onto a grating sieve. By shaking the grating sieve for 1 minute excess cornstarch flour was removed from the soft candies. Here the grating sieve was selected such that the soft candies remained on the grating sieve and the particles of the cornstarch flour fell through the grating sieve and could be collected thereunder in a container. In addition, the soft candies were blown clean with compressed air. Next, the soft candies were oiled in an oiling drum in order to avoid mutual adhesion of the soft candies and to impart a gloss to the soft candies. The oiled soft candies were now packed in a foil bag and then stored at 20° C. and an atmospheric humidity of less than 60%.

### Example 5—Soft Candy

Example 5 relates to a further production according to the invention of a further soft candy according to the invention. Example 5 was performed identically to example 4, differing however in that another cornstarch flour was used as the molding powder. In example 5, a cornstarch flour which had a particle size distribution characterized by a D₁₀ of 8.40 μm, a D₁₆ of 9.72 μm, a D₅₀ of 14.56 μm, a D₈₄ of 21.12 μm, a D₉₀ of 23.91 μm, a D₉₅ of 28.3 μm, and by a Q₁₀ of 17.56 vol. %, a Q₂₀ of 80.21 vol. %, a Q₄₀ of 99.72 vol. %, and a Q₅₀ of 99.87 vol. % was used. Further, the cornstarch flour had a water content of 14.1 g/100 g based on the cornstarch flour.

### Example 6—Soft Candy

Example 6 relates to a further production according to the invention of a further soft candy according to the invention. Example 6 was performed identically to example 4, differing however in that another cornstarch flour was used as the molding powder. In example 6, a cornstarch flour which had a particle size distribution characterized by a D₁₀ of 8.40 μm, a D₁₆ of 9.70 μm, a D₅₀ of 14.52 μm, a D₈₄ of 20.99 μm, a D₉₀ of 23.86 μm, a D₉₅ of 28.11 μm, and by a Q₁₀ of 17.69 vol. %, a Q₂₀ of 80.16 vol. %, a Q₄₀ of 99.21 vol. %, and a Q₅₀ of 99.88 vol. % was used. Further, the cornstarch flour had a water content of 6 g/100 g based on the cornstarch flour.

### Comparative Example 1—Hard Candy

Comparative Example 1 relates to the production not according to the invention of a hard candy not according to the invention.

Firstly a formula for a hard candy precursor mass was prepared by weighing out the raw materials. The formula consisted of
47 wt. % sucrose of purity 99.5%, a pH of 7, sweetness 100, and EC category I;
36 wt. % glucose syrup, a DE 42 SE was used, pH 4.8 to 5.3, dry substance ca. 80 wt. % of the glucose syrup, wherein the dry substance comprises 6 wt. % dextrose, 37 wt. % maltose, and 57 wt. % polysaccharide, each based on the dry substance;
15 wt. % water, compliant with the drinking water decree;
1.5 wt. % acid, citric acid monohydrate, residual water 8.6 wt. % based on the acid, acid strength 90, inversion rate 0.64;
0.25 wt. % dye, from plant extracts; and
0.25 wt. % flavoring, natural flavoring from fruit as concentrate;
   each based on the formula.

After this, a batch boiler was used for the boiling. The batch boiler is a double-walled steam-heated stirred vessel with two-stage stirrer, vapor extraction, manhole as filling port, steam valve, temperature sensor, needle valve, pivotable vacuum and discharge vessel, venting or blow valve and pressure display. The sucrose and the water of the formula were fed into the batch boiler and the sucrose dissolved at 110° C. Then the glucose syrup was added and the resulting solution end-boiled in the batch boiler to 140 to 142° C., to reach a dry substance content of 96 wt. % of the mass obtained. The boiling time was about 8 minutes. The heating and boiling were effected with constant stirring with the two-stage stirrer. Thereby, the heat input into the solution or mass was assisted and all raw materials homogenously mixed. Through the needle valve, the finished boiled mass was discharged in a fan shape into the vacuum vessel. In the vacuum vessel, the mass was subjected to vacuum for 2.5 minutes at about 0.8 bar. The vacuum was broken by means of the venting valve and then the dye, the flavoring and the acid added according to the formula, and a hard candy precursor mass was thus obtained. The temperature of the mass during this was 115 to 120° C. with a dry substance content or 98 to 99 wt. %.

Next, the hard candy precursor mass was conditioned on a cooling table. The cooling table is a double-walled stainless steel table with water circulation. Before the hard candy precursor mass was placed on the cooling table, the stainless steel table plate was greased with a release wax. The hard candy precursor mass was placed on the stainless steel table plate and kneaded in order to distribute the dye, the flavoring and the acid homogeneously. During this, the precursor mass was folded several times until a temperature of ca. 80 to 85° C. was reached. During this, the temperature of the table was regulated so that no condensation water was formed.

For the subsequent demolding of the precursor mass, a tapered roller was used. The tapered roller is electrical and has 4 conical tapers and an adjustable height cone trough. The conditioned precursor mass was shaped into a strand by rotatory movements of the conical tapers. During this, the cone trough was raised or lowered in order to achieve continuous feeding of the strand to the tapered rollers. Before the use of the tapered rollers, these were preheated electrically. The strand obtained by the shaping had a temperature of 75 to 80° C.

Next the strand was narrowed in a strand former. For this, the strand former comprises 4 pairs of rollers and is heatable. By means of a continuously regulatable strand speed, continuous feeding of the strand was achieved.

The subsequent stamping of the hard candies was effected in an automatic stamping machine of the Strada type from Hansel Processing GmbH, Hannover, Germany. The narrowed sugar strand coming from the strand former was linearly introduced into the automatic stamping machine and divided into pieces. The hard candies thus obtained, after the stamping, fell onto a distributor belt. In order to avoid deformation of the stamped hard candies, these had to be cooled directly afterwards. This was performed on a cooling belt by means of air of temperature in the range from 16 to 18° C. and a humidity of ca. 40%.

Next, the cooled hard candies were individually packed in a wrapping machine of the type Miniwrap BVK 2000 A/B from Robert Bosch GmbH, Gerlingen-Schillerhohe, Germany After this, the individually packed hard candies were packed in portions in foil bags and stored at 18 to 20° C. and an atmospheric humidity of less than 60%.

### Comparative Example 2—Soft Candy

Comparative Example 2 relates to the production not according to the invention of a soft candy not according to the invention. Comparative example 2 was performed identically to example 4, differing however in that another cornstarch flour was used as the molding powder. In Comparative example 2, a cornstarch flour which had a particle size distribution characterized by a D₁₀ of 12.3 μm, a D₅₀ of 18.2 μm, and a D₉₀ of 29.7 μm was used. Further, the cornstarch flour had a water content of 13.2 g/100 g based on the cornstarch flour.

Table 1 below summarizes the results of examples 1 to 3 and of comparative example 1 on hard candies. It is clear that with the process according to the invention (examples 1 to 3) hard candies of a great variety of shapes can be manufactured. In particular, the hard candies can be provided with a great variety of reliefs and embossments. This is markedly limited or more complicated in the process not according to the invention according to comparative example 1 with an automatic stamping machine. Further, the hard candies of examples 1 to 3 are free from burrs and seams (clean shape). The hard candies according to comparative example 1 show markedly undesired traces of the production process such as for example a seam or an undesired edge in the hard candy.

TABLE 1
Examples and comparative example for hard
candies (+ best result, − worst result)

| | Production | Variety of shape | Clean shape |
|---|---|---|---|
| Example 1 | Casting in molding | + | + |
| | powder | | |
| Example 2 | Casting in molding | + | + |
| | powder | | |
| Example 3 | Casting in molding | + | + |
| | powder | | |
| Comparative | Automatic strand former | − | − |
| Example 1 | and stamping machine | | |

Table 3 below summarizes the results of examples 4 to 6 and of comparative example 2 for soft candies. It is clear that the negative molds in the examples according to the invention are markedly more stable, i.e. less liable to destruction than is the case for the negative molds in comparative example 2 not according to the invention. Further, the soft candies in examples 4 to 6 can be demolded better than in comparative example 2, after the inversion of the powder tray, less cornstarch flour remains on the soft candies. As a result, the soft candies obtained according to the invention are also advantageous compared to those of comparative example 2 not according to the invention.

TABLE 2
Examples and comparative example for soft candies (++ best result, + worse than ++
and better than −, − worst result)

| | D₁₀/ | D₁₆/ | | Water content | Stability | |
|---|---|---|---|---|---|---|
| | D₅₀/ | D₈₄/ | Q₁₀/Q₂₀/ | of the molding | of the | Demoldability/ |
| | D₉₀ | D₉₅ | Q₄₀/Q₅₀ | powder | negative | powder residues |
| | [μm] | [μm] | [μm] | [g/100 g] | mold | on the hard candy |
| Example 4 | 8.49/ | 13.01/ | 13.9/76.6/ | 13.8 | + | + |
| | 14.57/ | 23.1/ | 95.95/ | | | |
| | 23.92 | 33.7 | 97.88 | | | |
| Example 5 | 8.4/ | 9.72/ | 17.56/80.2 | 14.1 | ++ | + |
| | 14.56/ | 21.12/ | 1/99.72/ | | | |
| | 23.91 | 28.3 | 99.87 | | | |
| Example 6 | 8.4/ | 9.7/ | 17.69/80.1 | 6 | ++ | ++ |
| | 14.52/ | 20.99/ | 6/99.21/ | | | |
| | 23.86 | 28.11 | 99.88 | | | |
| Comparative | 12.3/ | ~ | ~ | 13.2 | − | − |
| Example 2 | 18.2/ | | | | | |
| | 29.7 | | | | | |

The diagrams show:

FIG. 1a) an illustration of a process according to the invention;

FIG. 1b) a further illustration of a process according to the invention;

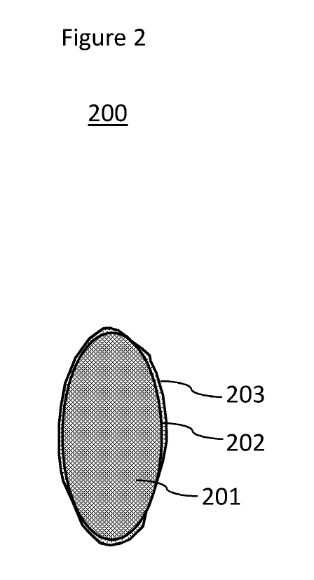

FIG. 2 a schematic cross-sectional representation of a product according to the invention in plan view;

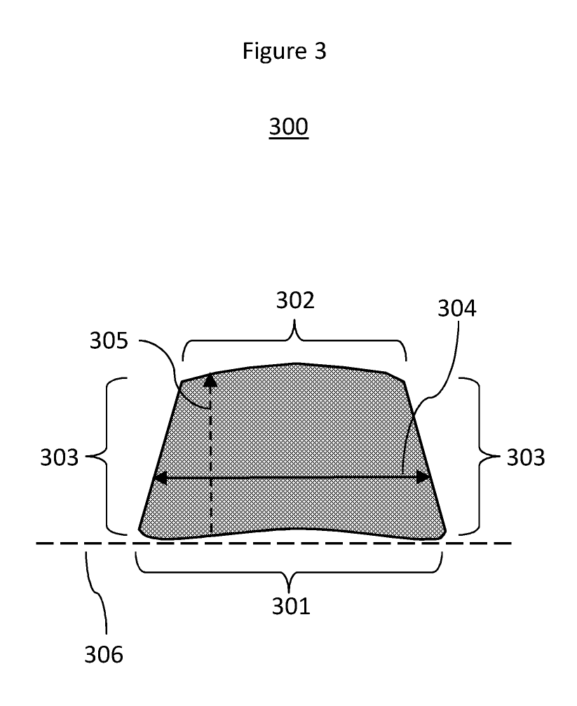

FIG. 3 a schematic cross-sectional representation of a hard candy according to the invention in side view;

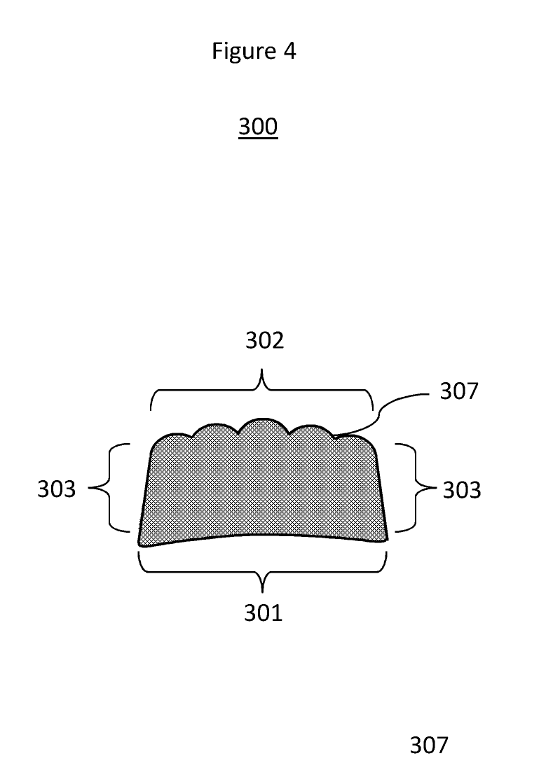

FIG. 4 a schematic cross-sectional representation of a further hard candy according to the invention in side view;

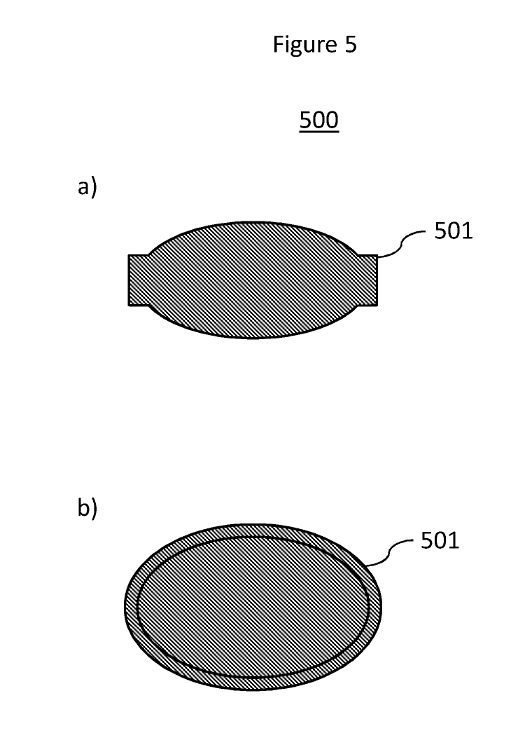

FIG. 5a) a schematic cross-sectional representation of a hard candy not according to the invention in side view;

FIG. 5b) a schematic representation of the hard candy not according to the invention in FIG. 5a) in plan view;

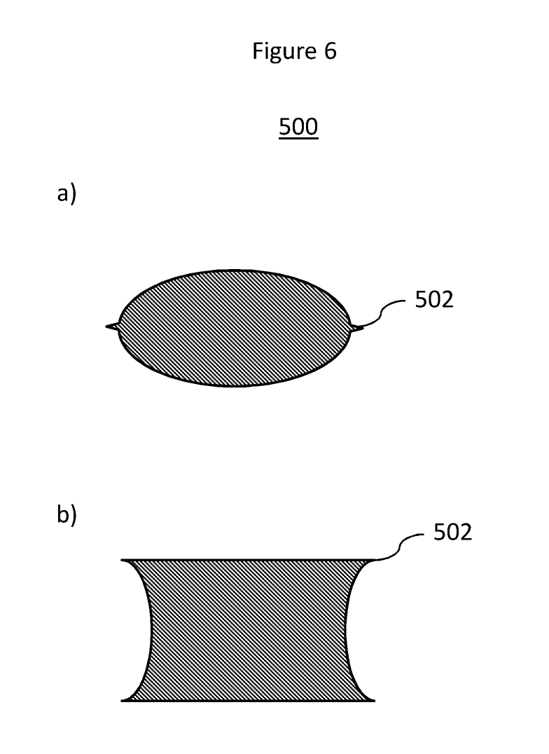

FIG. 6a) a schematic cross-sectional representation of a further hard candy not according to the invention in side view;

FIG. 6b) a schematic cross-sectional representation of a further hard candy not according to the invention in side view;

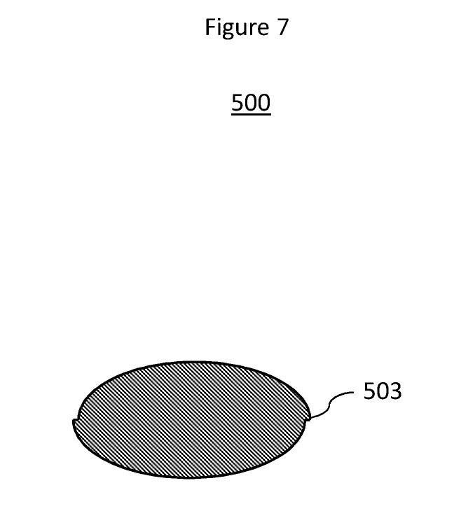

FIG. 7 a schematic cross-sectional representation of a further hard candy not according to the invention in side view;

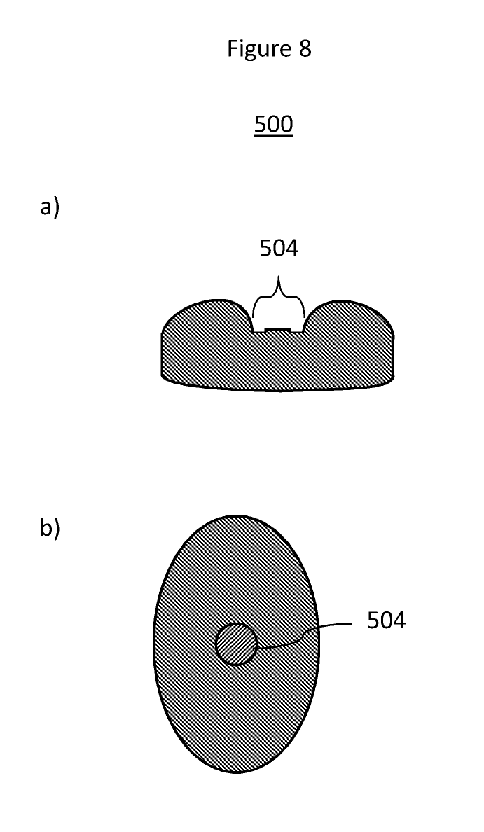

FIG. 8a) a schematic cross-sectional representation of a further hard candy not according to the invention in side view;

FIG. 8b) a schematic representation of the further hard candy not according to the invention in FIG. 8a) in plan view; and

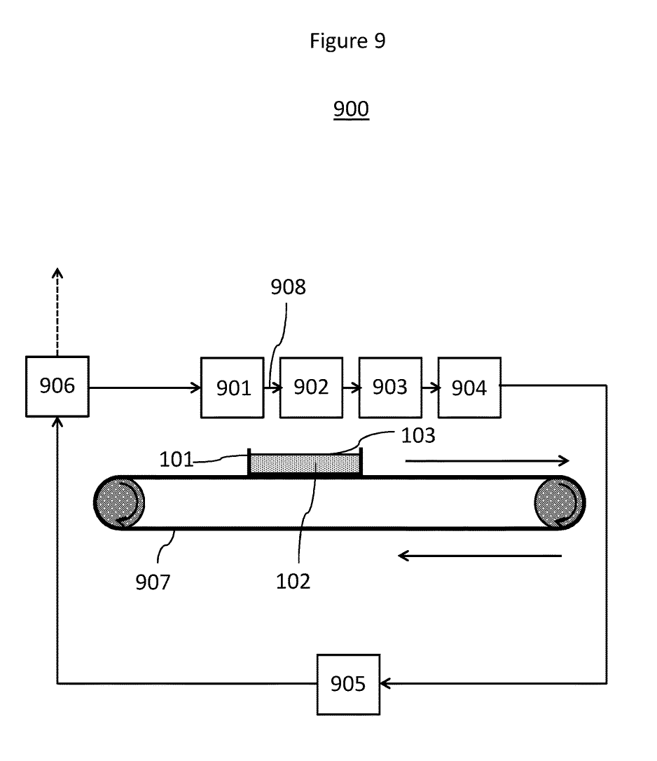

FIG. 9 a schematic representation of a device according to the invention for the production of hard candies.

FIG. 1a) shows an illustration of a process according to the invention 100. A schematic cross-sectional representation is shown of a support 101, wherein the support 101 is a tray 101. In the tray 101 is located a powder 102, wherein the powder 102 is a cornstarch flour 102. The cornstarch flour 102 contains a powder surface 103. The tray 101 is filled with the cornstarch flour 102 to the powder surface 103. The powder surface 103 contains negative molds 104. The negative molds 104 were stamped into the powder surface 103 with a punch. The cornstarch flour 102 has a particle size distribution characterized by a D₁₀ of 8.41 μm, a D₁₆ of 9.69 μm, a D₅₀ of 14.38 μm. a D₈₄ of 20.48 μm, a D₉₀ of 23.02 μm, a D₉₅ of 26.64 μm, and by a Q₁₀ of 17.76 vol. %, a Q₂₀ of 82.08 vol. %, a Q₄₀ of 99.07 vol. %, and a Q₅₀ of 99.45 vol. %.

FIG. 1b) shows a further illustration of a process according to the invention. The arrangement in FIG. 1a) is shown, wherein the negative molds 104 are filled with a confectionery precursor mass 105. The confectionery precursor mass 105 is a hard candy mass 105.

FIG. 2 shows a schematic cross-sectional representation of a product according to the invention 200 in plan view. The product 200 comprises a confectionary 201, a confectionery surface 202 and a flour 203. The confectionary 201 is a hard candy 201. The flour 203 is a cornstarch flour 203. The cornstarch flour 203 has a particle size distribution characterized by a D₁₀ of 8.41 μm, a D₁₆ of 9.69 μm, a D₅₀ of 14.38 μm. a D₈₄ of 20.48 μm, a D₉₀ of 23.02 μm, a D₉₅ of 26.64 μm, and by a Q₁₀ of 17.76 vol. %, a Q₂₀ of 82.08 vol. %, a Q₄₀ of 99.07 vol. %, and a Q₅₀ of 99.45 vol. %. The cornstarch flour 203 has a water content of 5 g/100 g based on the cornstarch flour 203. The cornstarch flour 203 is located on the confectionery surface 202.

FIG. 3 shows a schematic cross-sectional representation of a hard candy according to the invention 300 in side view. The hard candy 300 includes a surface. The surface consists of a bottom surface 301, a top surface 302, and a lateral surface 303. The top surface 302 lies opposite the bottom surface 301. The lateral surface 303 connects the top surface 302 with the bottom surface 301. The hard candy 300 is laid on a flat surface 306. A length of a diameter 304 of the hard candy 300 is a strictly monotonically decreasing function of a position on a connecting straight line 305 from the bottom surface 301 to the top surface 302. Here the diameter lies in a cross-sectional plane through the hard candy 300, which is oriented parallel to the flat surface 306. The bottom surface 301 is concave.

FIG. 4 shows a schematic cross-sectional representation of a further hard candy according to the invention 300 in side view. The hard candy 300 includes a surface. The surface consists of a bottom surface 301, a top surface 302, and a lateral surface 303. The top surface 302 lies opposite the bottom surface 301. The lateral surface 303 connects the top surface 302 with the bottom surface 301. A length of a diameter 304 (not shown) of the hard candy 300 is a strictly monotonically decreasing function of a position on a connecting straight line 305 (not shown) from the bottom surface 301 to the top surface 302. The top surface 302 comprises a relief 307. The relief 307 is a three-dimensional representation 307 of a part of a surface of a raspberry. The bottom surface 301 is concave.

FIG. 5a) shows a schematic cross-sectional representation of a hard candy not according to the invention 500 in side view. The hard candy 500 has a rim 501 running at least partly around the hard candy.

FIG. 5b) shows a schematic representation of the hard candy not according to the invention 300 in FIG. 5a) in plan view.

FIG. 6a) shows a schematic cross-sectional representation of a further hard candy not according to the invention 500 in side view. The hard candy 500 has a burr 502.

FIG. 6b) shows a schematic cross-sectional representation of a further hard candy not according to the invention 500 in side view. The hard candy 500 has a burr 502.

FIG. 7 shows a schematic cross-sectional representation of a further hard candy not according to the invention 500 in side view. The hard candy 500 has a seam 503. The seam 503 is a linear misalignment on a surface of the hard candy 500.

FIG. 8a) shows a schematic cross-sectional representation of a further hard candy not according to the invention 500 in side view. The hard candy 500 has a knock-out mark 504.

FIG. 8b) shows a schematic representation of the further hard candy not according to the invention 500 in FIG. 8a) in plan view.

FIG. 9 shows a schematic representation of a device according to the invention 900 for the production of hard candies in a process sequence 908. The process sequence 908 is a circuit which enables continuous operation of the production process. The device 900 comprises a first container 901, which is designed to receive a powder 102, here a cornstarch flour. The first container is connected with a powder outlet 901 such that the powder 102 can be passed from the first container 901 to the powder outlet 901 and via the powder outlet 901 a support 101, here a powder tray, can be filled with the powder 102. In the process sequence 908, a squeegee 902 is located downstream from the powder outlet 901. The squeegee 902 is designed to wipe off the powder 102 in the support 101 thereby obtaining a flat powder surface 103. Positioned downstream of the squeegee 902 is located a stamping device 903, which includes a plurality of molding punches which can be lowered into the powder surface 103, in order to create a plurality of negative molds in the powder surface 103. The negative molds are hard candy molds. Further, the device 900 includes a further container 904, designed to receive a liquid hard candy mass. The further container 904 is equipped with a heating system. Further, the further container 904 is connected to a hard candy mass outlet 904 such that the negative molds can be filled with the liquid hard candy mass via the hard candy mass outlet 904. Therein, the hard candy mass outlet 904 is a mogul nozzle. The hard candy mass outlet 904 is positioned downstream of the stamping device 903. A cooling device 905 is positioned downstream of the hard candy mass outlet 904. The cooling device 905 is a cooling room, suitable for cooling the hard candy mass in the negative molds for 1 to 5 hours at a cooling room temperature of 30° C. thereby obtaining a plurality of hard candies. A demolding device 906, which can invert the support 101, that is orientate it with the powder surface 103 pointing downwards, is located downstream of the cooling device 905. As a result, the powder 102 and the hard candies fall out of the support 101 onto a grating, which is part of the demolding device 906. The powder 102 falls through openings in the grating and the hard candies remain lying on the grating. In order to free the hard candies from powder residues, the grating can be shaken. The demolding device 906 is an inverting table. After the hard candies have been freed from the powder 102, they can leave the device as the end product according to the dotted arrow. The support 101 can remain in the device 900 and pass through a further process cycle. The device 900 further includes a conveying device 907, here a production line. The production line transports the support 101 under the powder outlet 901, from there to the squeegee 902, from there to the stamping device 903 under the molding punch, and from there under the hard candy mass outlet 904. The device 900 is a mogul plant.

### LIST OF REFERENCE SYMBOLS

100 process according to the invention
101 support
102 powder
103 powder surface
104 negative mold
105 confectionery precursor mass
200 product according to the invention
201 confectionery product
202 confectionery product surface
203 flour
300 hard candy according to the invention
301 bottom surface
302 top surface
303 lateral surface
304 length of a diameter
305 connecting straight line from the bottom surface to the top surface
306 flat surface
307 relief
500 hard candy not according to the invention
501 rim running at least partly around the hard candy
502 burr
503 seam
504 knock-out mark
900 device for the production of hard candies
901 first container with powder outlet
902 squeegee
903 stamping device
904 further container with hard candy mass outlet
905 cooling device
906 demolding device
907 conveying device
908 process flow

1. A process (100) comprising as process steps:
a) Providing a confectionery precursor mass (105),
wherein the confectionery precursor mass (105) is liquid;
b) Providing a support (101), carrying a powder (102),
wherein the powder (102) has a powder surface (103),
wherein the powder surface (103) comprises a plurality of negative molds (104);
c) Filling the negative molds (104) with the confectionery precursor mass (105);
d) Hardening the confectionery precursor mass (105);
wherein the powder (102) has a particle size distribution characterized by a
i) D₁₀ in a range from 6 to 10 μm,
ii) D₅₀ in a range from 12 to 16 μm, and
iii) D₉₀ in a range from 21 to 25 μm.

2. The process (100) as claimed in claim 1, wherein the particle size distribution of the powder (102) is further characterized by a
i) D₁₆ in a range from 8 to 11 μm,
ii) D₈₄ in a range from 19 to 22 μm, and
iii) D₉₅ in a range from 25 to 30 μm.

3. The process (100) as claimed in claim 1, wherein the particle size distribution of the powder (102) is further characterized by a
i) Q₁₀ in a range from 15 to 20 vol. %,
ii) Q₂₀ in a range from 78 to 85 vol. %,
iii) Q₄₀ in a range from 97 to 100 vol. %, and
iv) Q₅₀ in a range from 99 to 100 vol. %,
each based on the total volume of the powder (102).

4. The process (100) as claimed in claim 1, wherein the powder (102) is a flour.

5. The process (100) as claimed in claim 1, wherein the powder (102) has a water content in a range from 2 to 10 g/100 g based on the powder (102).

6. The process (100) as claimed in claim 1, wherein the confectionery precursor mass (105) is a hard candy mass.

7. The process (100) as claimed in claim 1, wherein the hardening of the confectionery precursor mass (105) in process step d) a conditioning for a period in a range from 0.5 to 10 hours to a temperature in a range from 25 to 65° C.

8. A confectionery product obtainable by a process (100) as claimed in claim 1.

9. A product (200) comprising a confectionery product (201), a confectionery surface (202) and a flour (203);
wherein the flour (203) at least partly superimposes the confectionery surface (202).

10. The product (200) as claimed in claim 9, wherein the confectionery product (201) is a hard candy.

11. The product (200) as claimed in claim 9 or 10, wherein the flour (203)
has a particle size distribution characterized by a
i) D₁₀ in a range from 6 to 10 μm,
ii) D₅₀ in a range from 12 to 16 μm, and
iii) D₉₀ in a range from 21 to 25 μm.

12. The product (200) as claimed in claim 9, wherein the flour (203)
has a particle size distribution characterized by a
i) D₁₆ in a range from 8 to 11 μm,
ii) D₈₄ in a range from 19 to 22 μm, and
iii) D₉₅ in a range from 25 to 30 μm.

13. The product (200) as claimed in claim 9, wherein the flour (203) has a particle size distribution characterized by a Q₁₀ in a range from 15 to 20%,
i) Q₂₀ in a range from 78 to 85%,
ii) Q₄₀ in a range from 97 to 100%, and
iii) Q₅₀ in a range from 99 to 100%,
each based on the total volume of the flour (203).

14. The product (200) as claimed in claim 9, wherein the flour (203) has a water content in a range from 2 to 10 g/100 g based on the flour (203).

15. A hard candy (300) having a surface;
wherein the surface consists of a bottom surface (301), a top surface (302), and a lateral surface (303);
wherein the top surface (302)
a) lies opposite the bottom surface (301),
b) is connected with the bottom surface (301) by the lateral surface (303);
wherein a length of a diameter (304) of the hard candy (300) is a strictly monotonically decreasing function of a position on a connecting straight line (305) from the bottom surface (301) to the top surface (302).

16. The hard candy (300) as claimed in claim 15, wherein the top surface (302) includes a relief (307).

17. The hard candy (300) as claimed in claim 15, wherein the hard candy (300) comprises none selected from the group consisting of a burr (502), a seam (503), a rim (501) running at least partly around the hard candy (300), and a knock-out mark (504).

18. The hard candy (300) as claimed in claim 15, wherein the bottom surface (301) is concave.

19. A use of a support and a flour for the production of confectionery;
wherein the support supports a flour;
wherein the flour
a) has a flour surface,
b) has a particle size distribution characterized by a
i) D₁₀ in a range from 6 to 10 μm,
ii) D₅₀ in a range from 12 to 16 μm, and
iii) D₉₀ in a range from 21 to 25 μm,
c) has a water content in a range from 2 to 8 g/100 g based on the flour;
wherein the flour surface comprises a plurality of negative molds.

20. A device (900), comprising
a) a first container (901), designed to receive a powder (102), wherein the first container (901) is connected to a powder outlet (901), designed for filling a support (101) with the powder (102);
b) a squeegee (902), wherein the squeegee (902)
i) is positioned downstream of the powder outlet (901), and
ii) is designed to wipe off the powder (102) in the support (101) thereby obtaining a powder surface (103);
c) a stamping device (903), wherein the stamping device (903)
i) is positioned downstream of the squeegee (902), and
ii) is designed to stamp a plurality of negative molds (104) into the powder surface (103);
d) a further container (904), designed to receive a liquid hard candy mass, wherein the further container (904) is connected to a hard candy mass outlet (904), designed for filling the negative mold (104) with the liquid hard candy mass, wherein the hard candy mass outlet (904) is positioned downstream of the stamping device (903);
e) a cooling device (905), wherein the cooling device (905)
i) is positioned downstream of the hard candy mass outlet (904), and
ii) is designed to cool the hard candy mass in the negative molds (104) thereby obtaining a plurality of hard candies;
f) a demolding device (906), wherein the demolding device (906)
i) is positioned downstream of the cooling device (905), and
ii) is designed to demold the hard candies from the negative molds (104); and
g) a conveying device (907), positioned and designed for conveying the support (101) downstream from the powder outlet (901) to the hard candy mass outlet (904).

21. The device (900) as claimed in claim 20, wherein the cooling device (905) is designed to cool the hard candy mass in the negative molds (104) at a cooling device temperature in a range from 25 to 55° C. for a cooling time in a range from 0.5 to 10 hours.

22. A process for the production of hard candies in the device (900) as claimed in claim 20.

23. The process as claimed in claim 22, wherein the hard candy mass in the negative molds (104) is conditioned at a cooling device temperature in a range from 25 to 55° C. for a period in a range from 0.5 to 10 hours.

24. A hard candy, obtainable by the process as claimed in claim 22.
